(19) United States
(12) Patent Application Publication
(10) Pub. No.: US 2016/0034660 A1
(43) Pub. Date: Feb. 4, 2016

(54) UTILIZATION OF RESOURCES IN A SUPPORT PLAN FOR A PATIENT

(71) Applicant: Hunhu Healthcare Inc., Eden Prairie, MN (US)

(72) Inventors: Michael Gene Emerson, Eden Prairie, MN (US); Richard Dean Dettinger, Eden Prairie, MN (US)

(21) Appl. No.: 14/812,910

(22) Filed: Jul. 29, 2015

Related U.S. Application Data
(60) Provisional application No. 62/030,462, filed on Jul. 29, 2014.

(51) Int. Cl. G06F 19/00

(52) U.S. Cl. CPC G06F 19/3425; G06F 19/3481; G06F 19/3418

(57) ABSTRACT

Embodiments of the invention include a system and a method for determining which portion of a care team should be contacted in response to an event regarding a patient, and contacting the portion of a care team that is determined to be the appropriate portion to be contacted. Other embodiments are disclosed herein.

This application claims the benefit of U.S. Provisional Application No. 62/030,462, filed Jul. 29, 2014, the contents of which are herein incorporated by reference.

### FIELD OF THE INVENTION

The present invention relates to utilizing resources or a care team to support or assist a patient. More specifically, the present invention relates to efficiently using available resource to assist a patient.

### BACKGROUND OF THE INVENTION

Patient refusal or inattention to following his or her care plan is an enormous problem for our health care system. A care plan can be set forth by a health care professional, such as the patient's doctor. A care plan can be designed to help the patient recover from a medical condition or procedure more completely or faster while also significantly lessen the risk of side effects or complications. A care plan can also be designed to help a patient live a healthier or safer life.

A landmark study by the New England Journal of Medicine documented that people waste $290 billion each year to lack of patient engagement in their care plan activities. This amount is in line with some of the most expensive diseases, such as diabetes, cancer, and coronary heart failure. Digging deeper into the problem, there are many problems that are preventable with improved education and adherence to a prescribed regimen of drugs, exercise and visits with appropriate medical personnel. In some cases adherence to a care plan is not possible or highly unlikely for a patient, because of a patient's inability to complete tasks on his/her own.

In many cases a patient is asked for emergency contacts, such as a person that should be contacted in regards to an emergency involving the patient. Patients are also frequently asked who his/her primary care doctor is. However, the patient's emergency contact might not be the most appropriate person to contact in an emergency or when the patient needs assistance, such as if the emergency contact is out of town and/or unreachable. A person will then try to contact a secondary emergency contact or retry contacting the primary emergency contact. Alternatively, in some scenarios the primary emergency contact will agree to assist the patient, when in reality the secondary emergency contact might be a more appropriate person to assist the patient in the task.

Accordingly, there is a need for a system to determine what resources are available to a patient in a time of need and how to best utilize those resources.

### SUMMARY OF THE INVENTION

Embodiments of the invention include a system for determining which portion of a care team should be contacted in response to an event regarding a patient, and contacting the portion of a care team that is determined to be the appropriate portion to be contacted, the system comprising: an event detection module configured to detect the occurrence of an event that requires a response from at least a portion of the care team; a care team selection module configured to select the portion of the care team to be contacted, wherein the selection of the portion of the care team comprises ranking each member of the care team on a first layer and a second layer, weighting the first layer based on the importance of the first layer in relation to the event, weighting the second layer based on the importance of the second layer in relation to the event, comparing the results of one or more members in the care team to determine which portion of the care team action is desired from, and selecting a first portion of the care team, wherein the first portion of the care team is the most desirable portion of the care team, a contacting module configured to contact the first portion of the care team, wherein the contacting module sends a communication to the first portion of the care team, a verification module configured to verify that the first portion of the care team received the communication or verify that the first portion of the care team did not receive the communication.

In an embodiment, the system includes a third layer, and the care team selection module is configured to incorporate the third layer into the selection of the desired portion of the care team.

In an embodiment, the first layer or the second layer comprises one or more of the following: proximity at time of event, proximity of residence, relationship, connectedness, legal, permission association, patient preference, religion and spirituality, comfort with shared information, medical history alignment, and expertise to need alignment.

In an embodiment, the event is a detected event.

In an embodiment, the event is detected with an electronic device on the patient's body.

In an embodiment, the event is a scheduled event.

In an embodiment, when the event is an emergency event and the verification module cannot verify the first portion of the care team has received the communication, a second portion of the care team is sent a communication.

In an embodiment, the weighting of the first layer and the second layer is dependent on the type of event that exists.

In an embodiment, the system includes sending a communication to a second portion of the care team, if the verification module does not verify the first portion of the care team received the communication within a time period.

In an embodiment, the length of the time period is dependent on the type of event.

In an embodiment, the second portion of the care team is the next highest ranking member of the care team after the first portion of the care team.

In an embodiment, when the system is unable to calculate a score for a layer for a portion of the care team, the portion of the care team the system is unable to calculate a score for is removed from consideration.

In an embodiment, once a portion of the care team is removed from consideration, the system does not calculate a score for that portion for alternate layers.

In an embodiment, scores for layers that are most likely to be unable to calculate a score for one or more portions of the care team are calculated first.

In an embodiment, one or more layer is dynamic.

In an embodiment, one of the dynamic layers is configured to be updated with GPS or other location detection device.

In an embodiment the invention provides a method for determining which portion of a care team should be contacted in response to an event regarding a patient, and contacting the portion of a care team that is determined to be the appropriate portion to be contacted, the system comprising detecting an event that requires a response from at least a portion of the care team; selecting a portion of the care team to be contacted, wherein the selection of the portion of the care team comprises ranking each member of the care team on a first layer and a second layer, weighting the first layer based on the importance of the first layer in relation to the event, weighting the second layer based on the importance of the second layer in relation to the event, and comparing the results of one or more members in the care team to determine which portion of the care team action is desired from; contacting the portion of the care team action is desired from, wherein contacting comprises a sending a communication to the portion of the care team; verifying that (1) the portion of the care team action is desired from received the communication or (2) that the portion of the care team did not receive the communication.

In an embodiment, the method includes contacting a second portion of the care team when the first portion of the care team did not receive the communication.

In an embodiment, the method includes verifying that the portion of the care team will or has completed the desired action.

In an embodiment, the event is a scheduled event.

In an embodiment, the first layer comprises a numerical representation of each member of the care team.

In an embodiment, when the first layer includes categorical information a numerical representation is associated with each category.

This summary is an overview of some of the teachings of the present application and is not intended to be an exclusive or exhaustive treatment of the present subject matter. Further details are found in the detailed description and appended claims. Other aspects will be apparent to persons skilled in the art upon reading and understanding the following detailed description and viewing the drawings that form a part thereof, each of which is not to be taken in a limiting sense. The scope of the present invention is defined by the appended claims and their legal equivalents.

### BRIEF DESCRIPTION OF THE FIGURES

The invention may be more completely understood in connection with the following drawings, in which:

FIG. 1 is a depiction of an environment in which the system could be used, according to an embodiment.

FIG. 2 is a schematic of a patient's available resources, according to an embodiment.

FIG. 3 is a schematic of steps in a system, according to an embodiment.

FIG. 4 is a schematic of steps in an event detection process, according to an embodiment.

FIG. 5 is a schematic of steps in a resource evaluation process, according to an embodiment.

FIG. 6 is a schematic of steps in a contacting process, according to an embodiment.

FIG. 7 is a schematic of steps in a confirmation process, according to an embodiment.

FIG. 8 is a schematic of different layers, according to an embodiment.

FIG. 9 is a schematic of a layer, according to an embodiment.

FIG. 10 is a depiction of an example computing environment wherein one or more of the embodiments set forth herein may be implemented.

While the invention is susceptible to various modifications and alternative forms, specifics thereof have been shown by way of example and drawings, and will be described in detail. It should be understood, however, that the invention is not limited to the particular embodiments described. On the contrary, the intention is to cover modifications, equivalents, and alternatives falling within the spirit and scope of the invention.

### DETAILED DESCRIPTION OF THE INVENTION

The embodiments of the present invention described herein are not intended to be exhaustive or to limit the invention to the precise forms disclosed in the following detailed description. Rather, the embodiments are chosen and described so that others skilled in the art can appreciate and understand the principles and practices of the present invention.

All publications and patents mentioned herein are hereby incorporated by reference. The publications and patents disclosed herein are provided solely for their disclosure. Nothing herein is to be construed as an admission that the inventors are not entitled to antedate any publication and/or patent, including any publication and/or patent cited herein.

At different times in a person's life he or she may require additional help or assistance with his or her medical care. For example, after a medical procedure, such as a surgery, the patient may be unable to drive for an extended period of time. During such a period of time the patient will need help from others, such as a care team. The care team can include one or more members that are able to help the patient with different aspects of the patient's recovery, such as driving the patient to and from physical therapy or follow up doctor appointments.

In another example, a person might have an established care team when the person is at risk for a situation that might require medical attention. The person might require assistance to receive the medical attention required, and therefore a care team can be established as a precautionary step. For example, an elderly patient could be at risk for a fall requiring medical attention and therefore have a care team established.

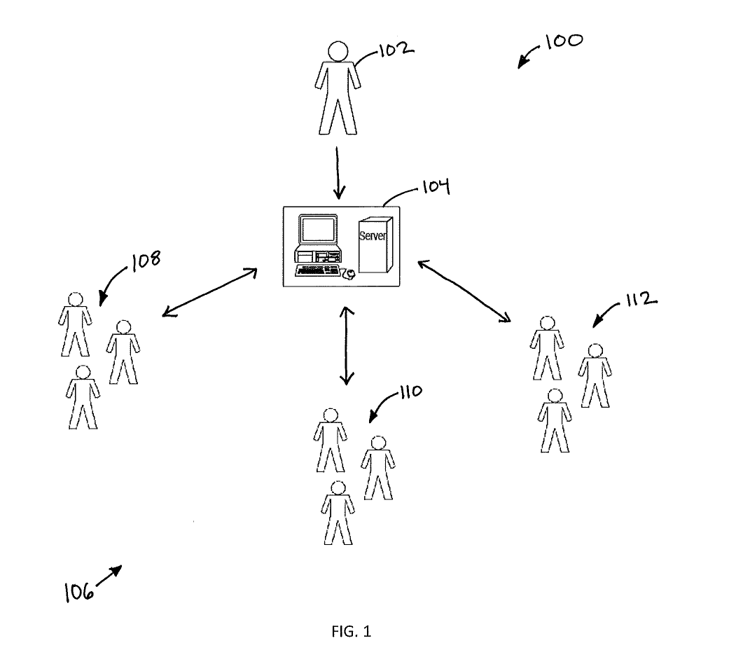

FIG. 1 is a depiction of an environment in which a system 100 can be implemented, according to an embodiment. The system 100 can be used to determine when action is needed from a care team, such as a member or portion of a care team. The system 100 can be used to determine which portion of the care team action is needed from. The system 100 can contact the portion of the care team that action is needed from. The system 100 can receive a communication from the contacted portion of the care team to confirm the contact portion of the care team's ability to complete the action needed or inability to complete the action needed.

The system 100 can be implemented for a patient 102, such as a patient 102 that needs assistance or is at risk for needing assistance in the future. The system 100 can be implemented with a processor 104 or other electronic/computing device. The system 100 can contact at least a portion of the care team 106. The care team 106 can be people or entities that are willing or able to help the patient 102 when the patient 102 is in need of assistance. The care team 106 can include the patient's 102 family 108, the patient's friends 110, and healthcare professionals 112, such as the patient's 102 primary doctor, specialist or other similar professionals.

Action can be needed from a member or a portion of the care team when an event arises that the patient needs assistance with. Such an event can be a scheduled event, a detected event, or an emergency event. In an embodiment, the action required from the care team can be transportation, such as to transport the patient to and from a location. In an embodiment the action required from the care team can be a checkup, such as to confirm the patient is doing well and is not in need of additional assistance. The action required from the care team can include any task the patient is unwilling or unable to complete on their own. The patient can be unwilling or unable to complete such a task for many different reasons, such as physical inability, mental inability, or the patient might be uncomfortable completing the task on his/her own.

The patient can be any person that is in need of assistance or could be in need of assistance. In an embodiment, the patient can be a person that has an illness or disease. The illness or disease might require the patient to require assistance in the future and therefore the patient establishes a care team to support him/her. In an embodiment, the patient can be a person that has had or will have a surgery or other medical procedure. The medical procedure can prevent the patient from being able to complete all of the necessary tasks in the future, such as rehabilitation. Therefore, the patient can establish a care team to help him/her in recovering from the medical procedure. In an embodiment, the patient can be elderly or living alone. As the patient ages, he/she might lose the ability to or lose confidence in his/her ability to complete all of the tasks necessary related to his/her health. Similarly, a patient living alone might not have the ability to complete all of the tasks necessary to his/her health, such as getting up from a fall. A care team can be established to support, aid or otherwise help a patient that will need help in the future or is at risk for needing help in the future.

An event that the patient needs assistance from his/her care team can include any task that the patient is unable to complete on his/her own or where friends and family need to be made aware of the patient situation. For example, if a patient is unable to drive, an event could include transportation to doctor appointments, physical therapy, to the pharmacist to refill a prescription, or other similar events. In another example, the event can include an unscheduled event, such as the patient falling and unable to stand back up. A portion of the care team can be required to aid the patient in getting back on his/her feet, or to meet the patient at the hospital if professional medical assistance is required related to the fall. A portion of the care team could meet the patient at the hospital for support, such as emotional support, or to talk with doctors to understand what steps need to take place for the patient's recovery.

A patient's care team can include anyone who is able and willing to help the patient, when the patient is in need. The care team can include one or more members. The care team can include the patient's family, the patient's friends and neighbors, and healthcare professionals. Each member of the care team might not necessarily be able or willing to help in every event that the patient needs help. In some embodiments, the care team can include more than one family member, more than one friend, and more than one healthcare professional. They type of event the patient needs assistance with can determine which portion of the care team is contacted to assist the patient.

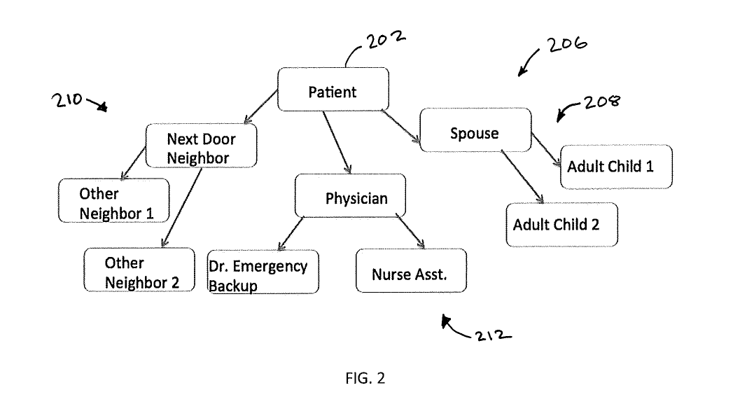

FIG. 2 is a schematic of a patient's 202 available resources, such as the patient's care team 206. The care team 206 can include a patient's family 208, a patient's friends 210, and healthcare professionals 212. The patient's family 208 can include a spouse, parents, adult children, siblings, or other relatives that would be able to assist the patient. The patient's friends 210 can include neighbors or other friends willing and able to assist the patient. The patient's healthcare professionals 212 can include a primary care doctor, a specialist, a nurse or other professionals.

The system can distinguish which member or members of the care team should be contacted when the patient needs assistance. For example, if the patient needs to be transported to the pharmacy to refill a prescription, an adult child that lives many miles away might not be the most appropriate person to assist, even though the patient might normally list the adult child as a primary contact. In such an example, a neighbor might be more appropriate to assist, such as if the pharmacy is near his/her residence. Alternatively, a patient might not be comfortable having a neighbor or friend know about the patient's medical problems, and therefore an adult child might be more appropriately chosen to assist the patient.

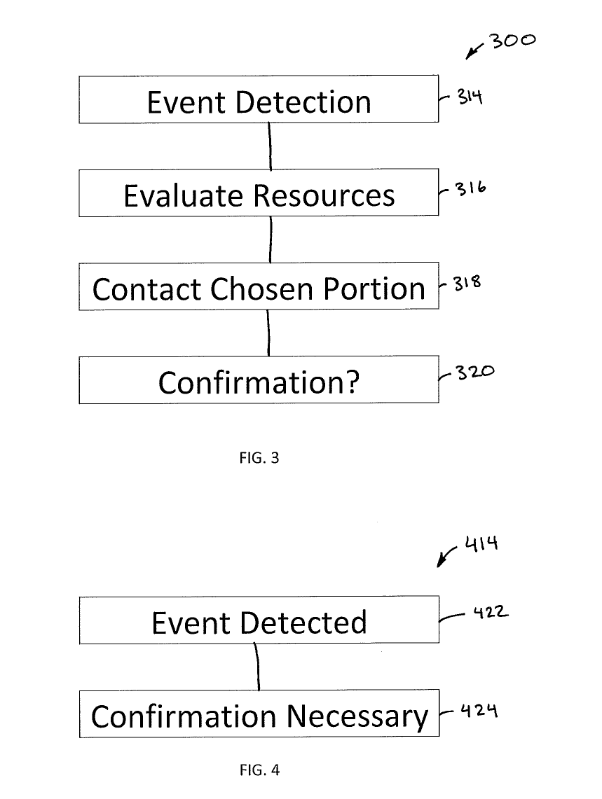

FIG. 3 is a schematic of steps in the system 300, according to an embodiment. In step 314, an event can be detected, such as an event where the patient needs or will need assistance. In some embodiments, the event that is detected can be in the future, such that the system 300 can plan for events when it is known the patient will need assistance.

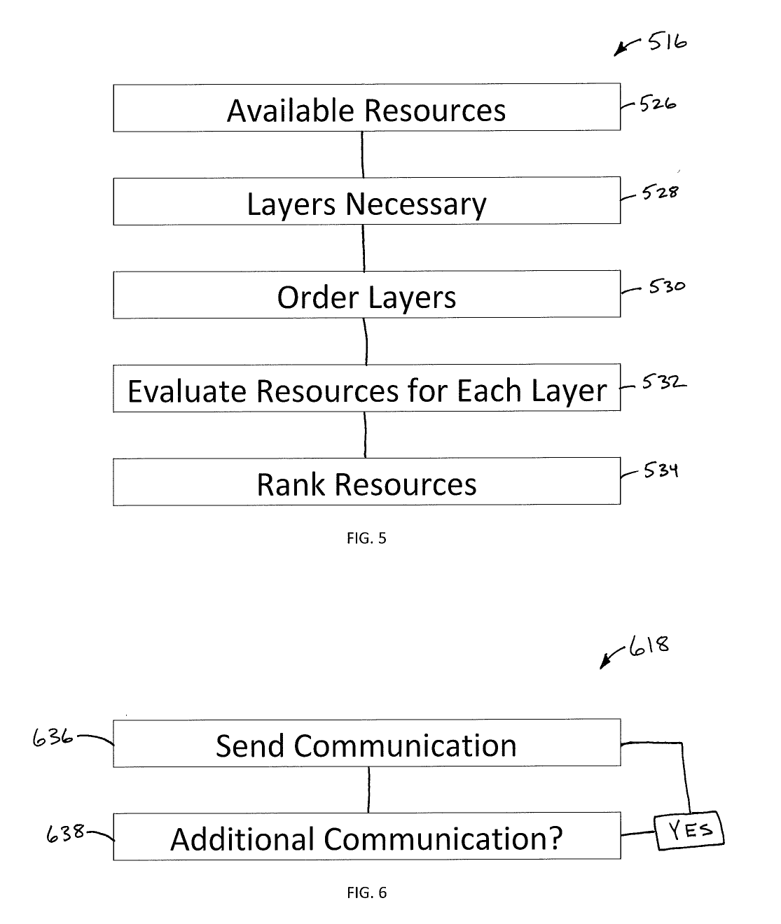

In step 316, the system can evaluate the resources available to assist the patient. As discussed below in reference to FIG. 5, the system can compare multiple factors or layers of each member of the care team. The system can weigh the different factors based on the importance of the factor in relation to the type of event the patient needs assistance with. The layers can be weighted different from patient to patient, based on the patient's priorities or values. After evaluating each member of the care team the system can rank the members from most appropriate member to assist the patient to the least appropriate member to assist the patient. In an embodiment, the most appropriate member of the care team can be referred to as the first portion of the care team. Similarly, the second portion of the care team can refer to the second most appropriate member of the care team, and so on for each member of the care team.

In step 318, the system can contact the chosen portion of the care team, such as the most appropriate member of the care team to assist the patient with the given event. The system can send a communication to the member of the care team. The communication can include one or more of the following pieces of information: the action needed from the care team member, the date and time the action needs to be completed, the location of the action, and any additional instructions the member will need to complete the assistance. The communication can be sent electronically, such as through email, a phone call, a text message or an electronic alert. The communication can be sent to an electronic device, such as a cellphone or a computer.

In step 320, the system can confirm or verify that the chosen portion of the care team will and is able to assist the patient. The system can require the chosen portion of the care team to respond to the communication, such as to accept or deny responsibility to assist the patient with the given event. When the chosen portion of the care team denies responsibility to assist the patient, the system can contact the next most appropriate portion of the care team to assist the patient. In an embodiment, if the system does not receive a reply from the chosen portion of the care team within a time period, the system will interpreted a non-response as denial of responsibility and contact the next most appropriate portion of the care team. In an embodiment, the time period can be as short as 30 second, 1 minute, 5 minutes, or 15 minutes. In an embodiment, the time period can be as long as 5 minutes, 15 minute, 1 hour, 3 hours, 6 hours, 12 hours, 24 hours, or 48 hours. The time period length can be dependent on the type of event the patient needs assistance with.

FIG. 4 is a schematic of steps in an event recognition process 414, according to an embodiment. In step 422, an event can be recognized, such as by detecting the event or a scheduled event approaching. In step 424, the event recognition process can determine if event requires a confirmation of a true event or not. In some cases a false event could be recognized, such as if a patient drops a fall detection device. The patient might not actually have fallen, so the care team would not need to be contacted.

In an embodiment, the event can be a scheduled event, such as an event on the patient's calendar. An event on the patient's calendar can include a doctor's appointment, a physical therapy appointment, or the like. Similarly, the event could be a reoccurring event, such as an event that occurs on a reoccurring schedule. For example, a patient might need assistance taking medicine every other day, or a patient might need assistance having a prescription refilled once a month.

In an embodiment, the event can be an emergency event. An emergency event can include a fall by the patient, a heart attack, or a similar unplanned emergency where the care team may need to assist the patient. In an emergency event, more than one member of the care team can be contacted. In an emergency event, the time period for confirmation by a member of the care team can be shorted in relation to a scheduled event.

In an embodiment, the event can be a detected event, such as an event that is detected by a monitoring device. In an embodiment, the patient could have an electronic device on his/her body, such as a device that can monitor or detect a condition. In an embodiment, the electronic device can detect a fall by the patient. In an embodiment, the electronic device can monitor the patient's glucose levels. In an embodiment, the electronic device can monitor the patient's respiration, pulse or blood pressure.

FIG. 5 is a schematic of steps in a resource evaluation process 516, according to an embodiment. In step 526, the process can include determining which resources are available, such as which portions or members of the care team are available to help assist the patient. Step 526 can include creating a list or database of the entire care team.

In step 528, the process can determine which layers or factors are necessary for determining what member or portion of the care team is most appropriate to assist the patient. The layers or factors in determining what member or portion of the care team is needed can include proximity at time of event, proximity of residence, relationship, connectedness, legal, permission association, patient preference, religion and spirituality, comfort with shared information, medical history alignment, and expertise to need alignment. It should be understood that additional layers or factors can also be used in determining what member or portion of the care team is needed.

In step 530, the layers can be arranged into the order in which the layers should be evaluated. If a member fails a layer or the process is unable to calculate a score of a member for a layer, such as a layer that ask if the member can drive the patient to an appointment, and the member does not have the ability to drive, then the member would be removed from consideration as being an appropriate portion of the care team to assist the patient. In an embodiment, the layers can be ordered, such that layers that members are more likely to fail are evaluated first. Once a member fails a layer, that member can be removed from consideration and that member does not need to be evaluated in regards to other layers. Conversely, in an embodiment, all or multiple layers can be calculated in parallel for performance optimization.

In step 532, the process can evaluate each member for each layer, removing members from the evaluation and consideration if the member fails a layer. In an embodiment, when the care team is originally established, each member can fill out a questionnaire or survey that includes information relevant to the layers, such that the process is able to evaluate each member for the appropriate layers. In an embodiment, the questionnaire or survey process of collecting information about care team members does not have to be limited to the time of care team generation. As layers are added over time, information that can be required for those layers can be requested from care team members via subsequent surveys and questionnaires thus creating a growing and evolving system of event handling over time.

In step 534, the members that are still available (have not failed a layer) can be ranked. The ranking can include weighting different layers that are more important to the patient or more important to the event. For example, if the event involves transportation to a checkup with the patient's primary care doctor, the patient might highly prefer a family member to accompany him/her to the appointment. However, in an emergency event, such as a fall, where a care team member needs to check on the wellbeing of the patient, a neighbor might be the most appropriate member. In some scenarios a patient's comfort with the care team member can be weighted more heavily than physical location, alternative scenarios can have the opposite weighting.

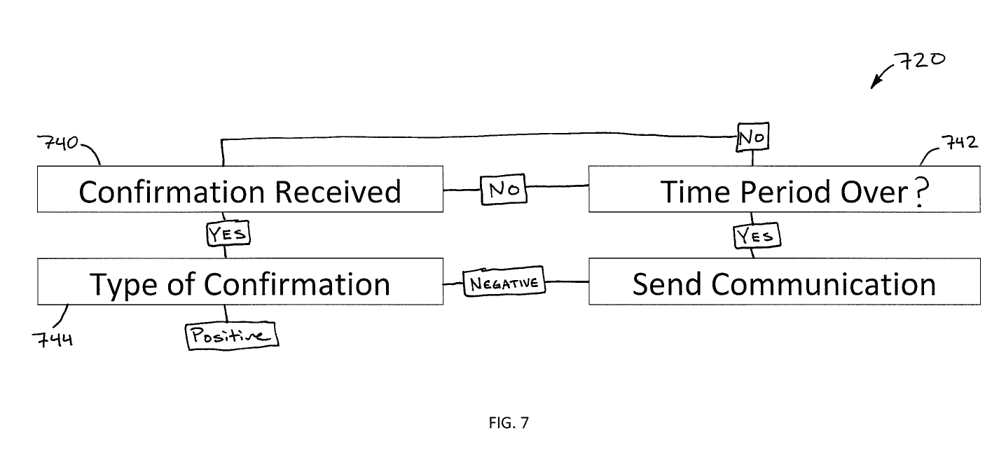

FIG. 6 is a schematic of a contacting process 618, such as a process to contact the desired portion of the care team. In step 636, the process can send a communication to the desired portion or member of the care team, such as the first portion of the care team if it is the first communication being sent. In step 638, the process can inquire if an additional communication is needed to be sent, such as if the confirmation/verification step (discussed in regards to FIG. 7) requires an additional communication to be sent.

FIG. 7 is a schematic of steps in a confirmation process 720, according to an embodiment. In step 740, the process can determine if a confirmation has been received. If a confirmation has not been received, in step 742 the process determines if the time period for waiting for a confirmation has passed. If the time period has passed, the contacting process sends a communication to the next highest member of the care team. If the time period has not passed, the process continues to wait for a confirmation to be received or for the time period to pass. If a confirmation is received, the process moves to step 744. In step 744, the process determines if the confirmation was positive, such as the member accepting responsibility to assist the patient, or negative, such as the member denying responsibility to assist the patient. If the confirmation is negative the system can send a communication to the next highest ranking portion of the care team.

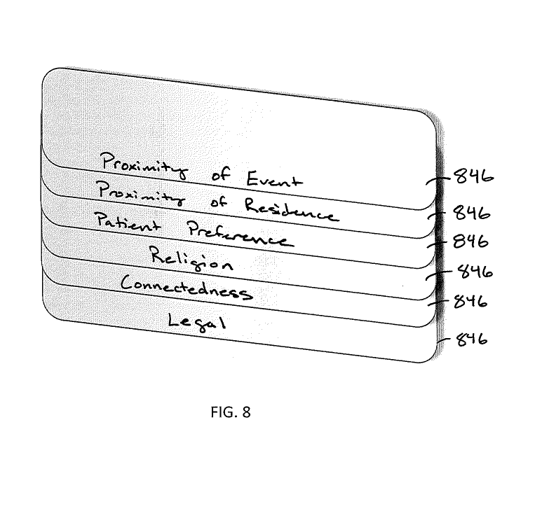

FIG. 8 is a schematic of different layers 846, according to an embodiment. In an embodiment, the system can include a first layer and a second layer. In an embodiment, the system can include a third layer, a fourth layer, a fifth layer and a sixth layer. In an embodiment, the system can include ten or more layers.

In an embodiment, the layers can include one or more of the following: proximity at time of event, proximity of residence, relationship, connectedness, legal, permission association, patient preference, religion and spirituality, comfort with shared information, medical history alignment, and expertise to need alignment.

In an embodiment, a layer can be dynamic, such that it changes over time. For example, a layer of last communication between the patient and the member can update over time. In another example, physical distance between the patient and the member can be updated in real time with the use of a GPS system, such as through the patient's and the member's cellphone. In an embodiment, one or more layers can be updated manually, such as through a web page, such as by the patient or the member of the care team.

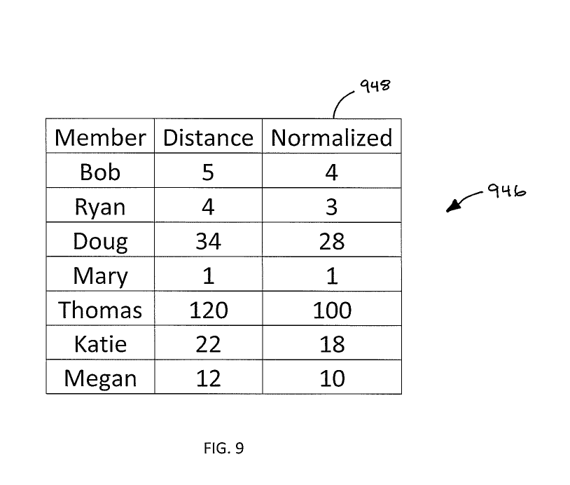

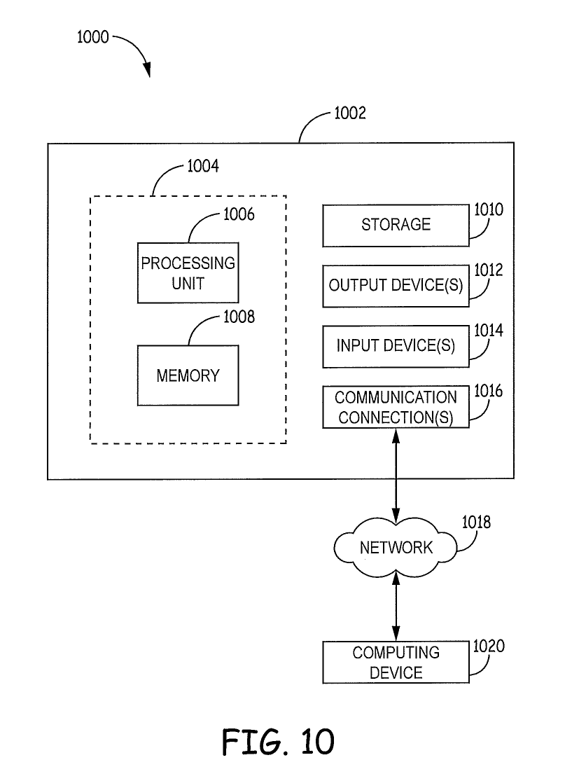

FIG. 9 is a schematic of a layer 946, according to an embodiment. The system can use known data, such as through the previously discussed questionnaire, to evaluate each member for each appropriate layer. In an embodiment, the system can normalize the scores for a layer, such as shown in column 948. The normalization can be represented by a percentage of the largest score.

In an embodiment, the layers can be evaluated in a linear manner, such as numerically, such as distance in number feet or amount minutes). In an embodiment, the layers can be evaluated categorically, such as in the same house/apartment, on the same floor of a multi-unit complex, in the same multi-unit complex, within driving, or within flying. In an embodiment, numerical values can be assigned to a layer that otherwise would not have numerical values associated with it, such as a categorical layer, such a religion. If a member has the same religion as the patient, that member can be given a 1. If a member has a different religion as the patient, that member can be given a 2, a 10, or a 100, such as to numerically distinguish between the patient's religion and the member's religion. In another example, patient preference can be assigned a number, such as 1 through 100. The patient can assign a preference, such as when he/she fills out a questionnaire.

In many scenarios a patient can be assigned a care plan. A patient can be assigned a care plan to help the patient recover from a medical procedure, such as a surgery. For example, the care plan can include taking prescription medications once a day and physical therapy once a week. A patient can be assigned a care plan to help improve the patient's overall health, such as to lose weight. For example, the care plan can include exercising a set number of times per week and follow up appointments with the doctor. A care plan can be at least partially designed by a healthcare provider, such as the patient's doctor.

The care plan can include a sequence of activities prescribed by a healthcare professional to a patient for the purpose of healing, rehabilitating, or generally improving one's health. A care plan can include a series of tasks, such as activities (usually adherence to a prescribed course of action), community interactions, communications, goals, rewards, or responses to some measured state of health. The care plan can include a series of tasks to be attempted or accomplished over a period of time. The care plan can include a set of outcomes to be achieved at various points along the timeline. These outcomes can be measured by the patient, the health care provider, or automatically. The care plan can include a sequence of educational content that is consumed by the patient. The care plan can include a measure or measures of how well the patient adheres to the prescribed course of action. In various embodiments, a care plan can include one or more of the following: the patient is required to take vitals and record the results, patient is required to take medications, the patient self-monitors for change in symptoms or medication side effects, and rehab activities.

A task included in a care plan can include any step or goal that helps the patient achieve the end goal of the care plan. The process of adapting a care plan for an individual patient can be automated. In an embodiment, each task can be codified, such as to allow the system to better understand each task. In an embodiment, a task can include a classification, a level, a duration, and a frequency. For example a task of walking for 30 minutes a day can be classified as an exercise at a moderate level for a duration of 30 minutes with a frequency of daily. The system can automatically codify each task in the care plan after it is entered by the healthcare professional.

Adherence to a care plan can include alignment between the patient's behaviors and the tasks included in the care plan. The closer the patient's behaviors align or match with the tasks included in the care plan, the better the patient is following or adhering to the care plan, and hopefully the patient will therefore have a higher likelihood of meeting the goal(s) of the care plan.

In many scenarios, the care team can greatly influence the ability of a patient to adhere to his or her care plan. In various embodiments, prior to implementing the care plan, the care team can be established. The care team can be established, such as the members of the care team being identified as a member of the care team. Further, each care team member can have a support plan as a part of the care plan. The support plan can include steps that the member of the care team is intended to accomplish in order to help the patient adhere to his/her care plan. The support plan can be unique for each member of the care team, such that each member's support plan is directed at the member's role.

As discussed above, the care team can have responsibility to help the patient adhere to the care plan when the patient cannot physically do so on his/her own, such as when the patient is unable to drive to a doctor's appointment. Additionally, the care team can have other responsibilities, such as to encourage or motivate the patient to adhere to the care team. The care team can further provide the patient with social interaction. In various embodiments, one or more care team member can be responsible for ensuring the patient has social interaction. The care plan can include how often (frequency) the patient should have social interaction and how long (duration) the social interaction should last. Support plans can include how often the specified care team member should interact with the patient and for how long the interaction should last. The care plan can include a schedule of social interaction, such as which days and at what time social interaction should take place. The care plan can specify what type of social interaction the patient should have; for example, face to face, phone call, or video conference.

In various embodiments, the content of the social interaction can be evaluated. For example, patient inquiries about certain symptoms or topics can lead to additional conditions or symptoms of the patient being revealed. In various embodiments, the content of the social interaction can be evaluated by speech analytics, such as to recognize any changing patterns in the patient's communications. In some embodiments, a slow down in social velocity might indicate the patient is not adhering to the care plan and can trigger review of the care plan, review of the patient's adherence to the care plan, or a review of the care team's members or support.

FIG. 10 shows an example of a computing device 1002 within the system 210, which can be used to carry out the embodiments described herein. Example computing devices include, but are not limited to, personal computers, server computers, hand-held or laptop devices, tablet computers, mobile devices, mobile phones, Personal Digital Assistants (PDAs), media players, multiprocessor systems, consumer electronics, mini computers, mainframe computers, and distributed computing environments that include any of the above systems or devices.

In one configuration, the computing device 1002 includes at least one processor 1006 and at least one memory component 1008. Depending on the exact configuration and type of computing device, the memory component 1008 may be volatile (such as RAM, for example), non-volatile (such as ROM, flash memory, etc., for example) or an intermediate or hybrid type of memory component. This combination of the processing unit 1006 and the memory unit 1008 is illustrated in FIG. 10 by dashed line 1004.

In some embodiments, device 1002 may include additional features, additional functionality or both. For example, device 1002 may include one or more additional storage components 1010, including, but not limited to, a hard disk drive, a solid-state storage device, and/or other removable or non-removable magnetic or optical media. In one embodiment, the storage component 1010 comprises non-transitory computer readable storage medium. In one embodiment, computer-readable and processor-executable instructions implementing one or more embodiments provided herein are stored in the storage component 1010. The storage component 1010 may also store other data objects, such as components of an operating system, executable binaries comprising one or more applications, programming libraries (e.g., application programming interfaces (APIs), media objects, and documentation. The computer-readable instructions may be loaded in the memory component 1008 for execution by the processor 1006.

The computing device 1002 may also include one or more communication components 1016 that allows the computing device 1002 to communicate with other devices. The one or more communication components 1016 may comprise (e.g.) a modem, a Network Interface Card (NIC), a radiofrequency transmitter/receiver, an infrared port, and a universal serial bus (USB) USB connection. Such communication components 1016 may comprise a wired connection (connecting to a network through a physical cord, cable, or wire) or a wireless connection (communicating wirelessly with a networking device, such as through visible light, infrared, or one or more radio frequencies.

The computing device 1002 may include one or more input components 1014, such as keyboard, mouse, pen, voice input device, touch input device, infrared cameras, or video input devices, and/or one or more output components 1012, such as one or more displays, speakers, and printers. The input components 1014 and/or output components 1012 may be connected to the computing device 1002 via a wired connection, a wireless connection, or any combination thereof. In one embodiment, an input component 1014 or an output component 1012 from another computing device may be used as input components 1014 and/or output components 1012 for the computing device 1002.

The components of the computing device 1002 may be connected by various interconnects, such as a bus. Such interconnects may include a Peripheral Component Interconnect (PCI), such as PCI Express, a Universal Serial Bus (USB), firewire (IEEE 1394), an optical bus structure, and the like. In another embodiment, components of the computing device 1002 may be interconnected by a network. For example, the memory component 1008 may be comprised of multiple physical memory units located in different physical locations interconnected by a network.

Those skilled in the art will realize that storage devices utilized to store computer readable instructions may be distributed across a network. For example, a computing device 1020 accessible via a network 1018 may store computer readable instructions to implement one or more embodiments provided herein. The computing device 1002 may access the computing device 1020 and download a part or all of the computer readable instructions for execution. Alternatively, the computing device 1002 may download pieces of the computer readable instructions, as needed, or some instructions may be executed at the computing device 1002 and some at computing device 1020.

An exemplary computer-readable medium (e.g., a CD-R, DVD-R, or a platter of a hard disk drive) may be encoded with computer-readable data. This computer-readable data in turn comprises a set of computer instructions that, when executed by the processor 1006 of the computer device 1002, cause the computer device to operate according to the embodiments presented herein. In one such embodiment, the processor-executable instructions may be configured to cause the computer device to perform a method of evaluating a patient. Some embodiments of this computer-readable medium may comprise a non-transitory computer-readable storage medium (e.g., a hard disk drive, an optical disc, or a flash memory device) that is configured to store processor-executable instructions configured in this manner. Many such computer-readable media may be devised by those of ordinary skill in the art that are configured to operate in accordance with the techniques presented herein.

The processor can include an event detection module configured to detect the occurrence of an event. The event that is detected can require a response from a portion of the care team. The event can be a scheduled event, such as a doctor appointment or an appointment to refill a prescription. The event can be an emergency event, such as a fall or a heart attack.

The processor can include a care team selection module configured to select the portion of the care team to be contacted. The portion of the care team that will be contacted can be the portion of the care team that ranks highest when evaluating the portions of the care team for assistance with the specific event. The ranking can be based on the different layers that are evaluated. In an embodiment, the layers can be weighted, such that the layers more important to the event are weighted more heavily than layers that are less important to the event. The layers that are evaluated can be dependent on the type of event the patient requires assistance with. In an embodiment, certain layers can be evaluated for a first type of event and different layers can be evaluated for a second type of event. The different portions of the care team can be compared to each other to determine which member of the care team action is desired from. The portion of the care team action is desired from can be selected.

The processor can include a contacting module configured to contact the first portion of the care team, such as the portion of the care team action is desired from and was selected. The contacting module can send a communication, such as an email, a phone call, a voice mail, a text message or the like, to the first portion of the care team. The communication can alert the first portion of the care team of that action is needed from the first portion of the care team. The communication can include the patient information, such as the patient's name or location. The communication can include event information, such as the event the first portion of the care team needs to help with. The communication can include time or date information, such as when the first portion of the care team needs to provide the necessary action. The contacting module can contact a second portion of the care team, if the first portion of the care team is unable or unwilling to complete the action required. Similarly, the contacting module can contact a third portion, fourth portion, and so on, if there are multiple portions of the care team that are unable or unwilling to complete the action required.

The processor can include a verification module configured to verify that the first portion of the care team received the communication or verify that the first portion of the care team did not receive the communication. The verification module can require the contacted portion of the care team to send a confirmation communication or a rejection communication. The contact portion of the care team can send a confirmation communication, such as to confirm that they have seen the communication and are able to complete the required action. The contact portion of the care team can send a rejection communication, such as to confirm that they are not able to perform the required action. In an embodiment, if the contacted portion of the care team has not sent a confirmation communication after a time period, it is assumed that the contacted portion is unable to perform the required action. The length of the time period can be dependent on the type of event or the type of action required.

It should be noted that, as used in this specification and the appended claims, the singular forms “a,” “an,” and “the” include plural referents unless the content clearly dictates otherwise. Thus, for example, reference to a composition containing “a compound” includes a mixture of two or more compounds. It should also be noted that the term “or” is generally employed in its sense including “and/or” unless the content clearly dictates otherwise.

It should also be noted that, as used in this specification and the appended claims, the phrase “configured” describes a system, apparatus, or other structure that is constructed or configured to perform a particular task or adopt a particular configuration to. The phrase “configured” can be used interchangeably with other similar phrases such as arranged and configured, constructed and arranged, constructed, manufactured and arranged, and the like.

All publications and patent applications in this specification are indicative of the level of ordinary skill in the art to which this invention pertains. All publications and patent applications are herein incorporated by reference to the same extent as if each individual publication or patent application was specifically and individually indicated by reference.

The invention has been described with reference to various specific and preferred embodiments and techniques. However, it should be understood that many variations and modifications may be made while remaining within the spirit and scope of the invention.

1. A system for determining which portion of a care team should be contacted in response to an event regarding a patient, and contacting the portion of a care team that is determined to be the appropriate portion to be contacted, the system comprising:
(a) an event detection module configured to detect the occurrence of an event that requires a response from at least a portion of the care team;
(b) a care team selection module configured to select the portion of the care team to be contacted, wherein the selection of the portion of the care team comprises ranking each member of the care team on a first layer and a second layer, weighting the first layer based on the importance of the first layer in relation to the event, weighting the second layer based on the importance of the second layer in relation to the event, comparing the results of one or more members in the care team to determine which portion of the care team action is desired from, and selecting a first portion of the care team, wherein the first portion of the care team is the most desirable portion of the care team,
(c) a contacting module configured to contact the first portion of the care team, wherein the contacting module sends a communication to the first portion of the care team,
(d) a verification module configured to verify that the first portion of the care team received the communication or verify that the first portion of the care team did not receive the communication.

2. The system of claim 1, further comprising a third layer, and wherein the care team selection module is configured to incorporate the third layer into the selection of the desired portion of the care team.

3. The system of claim 1, wherein the first layer or the second layer comprises one or more of the following: proximity at time of event, proximity of residence, relationship, connectedness, legal, permission association, patient preference, religion and spirituality, comfort with shared information, medical history alignment, and expertise to need alignment.

4. The system of claim 1, wherein the event is a detected event.

5. The system of claim 4, wherein the event is detected with an electronic device on the patient's body.

6. The system of claim 1, wherein the event is a scheduled event.

7. The system of claim 1, wherein when the event is an emergency event and the verification module cannot verify the first portion of the care team has received the communication, a second portion of the care team is sent a communication.

8. The system of claim 1, wherein the weighting of the first layer and the second layer is dependent on the type of event that exists.

9. The system of claim 1, further comprising sending a communication to a second portion of the care team, if the verification module does not verify the first portion of the care team received the communication within a time period.

10. The system of claim 9, wherein the length of the time period is dependent on the type of event.

11. The system of claim 7, wherein the second portion of the care team is the next highest ranking member of the care team after the first portion of the care team.

12. The system of claim 1, wherein when the system is unable to calculate a score for a layer for a portion of the care team, the portion of the care team the system is unable to calculate a score for is removed from consideration.

13. The system of claim 12, wherein once a portion of the care team is removed from consideration, the system does not calculate a score for that portion for alternate layers.

14. The system of claim 1, wherein scores for layers that are most likely to be unable to calculate a score for one or more portions of the care team are calculated first.

15. The system of claim 1, wherein one or more layer is dynamic.

16. The system of claim 15, wherein one of the dynamic layers is configured to be updated with GPS or other location detection device.

17. A method for determining which portion of a care team should be contacted in response to an event regarding a patient, and contacting the portion of a care team that is determined to be the appropriate portion to be contacted, the system comprising:
detecting an event that requires a response from at least a portion of the care team;
selecting a portion of the care team to be contacted, wherein the selection of the portion of the care team comprises ranking each member of the care team on a first layer and a second layer, weighting the first layer based on the importance of the first layer in relation to the event, weighting the second layer based on the importance of the second layer in relation to the event, and comparing the results of one or more members in the care team to determine which portion of the care team action is desired from;
contacting the portion of the care team action is desired from, wherein contacting comprises a sending a communication to the portion of the care team;
verifying that (1) the portion of the care team action is desired from received the communication or (2) that the portion of the care team did not receive the communication.

18. The method of claim 17, comprising contacting a second portion of the care team when the first portion of the care team did not receive the communication.

19. The method of claim 17, comprising verifying that the portion of the care team will or has completed the desired action.

20. The method of claim 17, wherein the event is a scheduled event.
